(19) United States
(12) Patent Application Publication
(10) Pub. No.: US 2025/0322761 A1
(43) Pub. Date: Oct. 16, 2025

(54) LEARN BY TEACHING PLATFORM WITH AI-BASED TEACHABLE AGENTS AND GENERATIVE AI-BASED QUESTION MANAGEMENT

(71) Applicant: Knowalla, Inc., El Cerrito, CA (US)

(72) Inventors: Connor HAUGH, Somerville, MA (US); Olivia TOMAENO, El Cerrito, CA (US)

(73) Assignee: Knowalla, Inc., El Cerrito, CA (US)

(21) Appl. No.: 19/176,686

(22) Filed: Apr. 11, 2025

Related U.S. Application Data
(60) Provisional application No. 63/633,476, filed on Apr. 12, 2024.

(51) Int. Cl. G09B 7/02; G06N 5/022

(52) U.S. Cl. CPC G09B 7/02; G06N 5/022

(57) ABSTRACT

In an approach to a learn by teaching platform, one or more processors display a graphic user interface that includes a first portion configured to enable a user to create a knowledge graph for a learning module. The one or more processors create the knowledge graph based on inputs received from the first portion of the graphic user interface. The one or more processors can select one or more questions for a teachable agent to answer using the created knowledge graph. In response to receiving answers for the one or more questions, the one or more processors generate a real-time visualization of thought processes of the teachable agent.

### CROSS-REFERENCE TO RELATED APPLICATIONS

This application claims priority benefit to U.S. Provisional Patent Application No. 63/633,476, filed Apr. 12, 2024, entitled “LEARN BY TEACHING PLATFORM WITH AI-BASED TEACHABLE AGENTS AND GENERATIVE AI-BASED QUESTION MANAGEMENT”, which is hereby incorporated herein by reference in its entirety.

### FIELD OF THE INVENTION

The invention relates to a learning-by-teaching (LBT) computer platform and methods with AI-based teachable agents with recursive feedback, whereby through use of the technology, a user studies a topic, provides an explanation of the topic to an AI agent, a question management component generates questions/problems about the topic and, as the agent applies what it learned from the user to solve problems and answer questions, the system displays the agent so that the user can watch the agent's performance to provide the user with indirect feedback about their own understanding of the topic.

### BACKGROUND

Many online learning systems are known, but all have limitations and drawbacks. Both students and teachers struggle to identify and address knowledge gaps. Traditional practice and assessment solutions typically do not give sufficient insight into student thinking. Students struggle to identify what they do not know, making it hard to know exactly what to study. Teachers often lack visibility into student reasoning, making it hard to know exactly where and why things might have gone wrong. For example, with multiple choice tests, all teachers see is an answer, not how the student thought about choosing the answer.

Existing practice, assessment, and tutoring tools suffer from various technical limitations that result in a failure to strike a balance between engagement and efficacy. One-on-one tutoring can help with these problems, but often schools are resource-constrained and this is not a viable option. Nor is this approach scalable. Many edtech solutions overly rely on multiple choice questions. It is difficult for teachers to understand a student's reasoning when answers are multiple choice. Some learning solutions focus more on student engagement and personalized algorithms. Some emerging AI solutions subjugate students to passively ‘learn’ from a chat bot, that teaches the student, and dictates the pace and direction of learning, depriving students of a sense of agency. These and other technology solutions suffer from other drawbacks.

The Illusion of Explanatory Depth (IOED) is a phenomenon that refers to humans' tendency to overestimate their knowledge and comprehension of the world (Rozenblit & Keil, 2002). In other words, we tend to think we know more than we actually do. The implications of this propensity are uniquely serious in the context of education because success and opportunities are so often determined by the extent to which students can demonstrate their understanding, both through speaking and writing. It is easy to conflate recognition with understanding; that is, students may recognize the material as they study it without fully understanding it, which sends a false signal that they are prepared to demonstrate their knowledge on an assessment. Especially for students with low academic self-esteem and motivation, it can be incredibly discouraging to invest time studying only to find that they didn't study right or study enough.

The average high schooler takes dozens of tests every year, yet most students are never explicitly taught how to study. A teacher can tell students what the expectations are for a test, but that doesn't mean students will be able to judge whether they are prepared to meet those expectations. Research shows that students often employ ineffective study strategies like rereading and cramming (Karpicke et al., 2009) and over-studying the information that they know best while under-studying the information that is confusing (Winnie & Azevedo, 2014). Especially at the high school level, effectively preparing for assessment takes much more than just intellectual ability; students need to have a clear sense of what they know and what they do not know in order to allocate their study time effectively.

Unfortunately, gaining this level of awareness about one's own understanding, referred to herein as “metacognition” is much easier said than done. Students need help identifying the limitations of their understanding, and need a way to sort and keep track of the topics they do understand versus those they are confused about.

There is a need for a solution that teaches students how to test and calibrate their understanding to change the way they study. If students could identify their knowledge gaps before they took a test, they would be able to allocate their study more appropriately and effectively and, as a result, would be set up for an empowering and motivating assessment experience. Prior tools and teaching techniques fail to provide practical, effective and scalable solutions to these and other known problems.

### SUMMARY

The computer-implemented platform described herein is believed to be the first technical solution to scale the LBT approach, a proven technique for improving student comprehension, and provide a technical solution for applying recursive feedback and the protégé effect, which is when students feel responsible for another's learning and thus spend more time engaging with the learning material. through a technology platform using the novel features, functions and methods described herein. The integration of this combination of features into a single technology platform is one aspect of the invention. Other novel features and functions are described herein.

The platform puts users in the role of a tutor, with the agent as the tutee, and guides the student through a multi-part cycle; prepare; teach; observe, repeat. Users prepare by gathering and studying relevant information and resources about a topic, explain concepts to their agent via a user interface (UI), and then watch their agent (via the UI) apply the information they learned from the explanation on practice problems, thereby giving users unique insight into their own conceptual understanding based on the performance of their agent. After observing the character's performance, the student can enter additional explanations via the UI to further teach the character about the topic.

The platform enables the generation, storage and processing of unique data to quantitatively assess and graphically display novel insights, including insights for the teacher into how a student is thinking (individually) or as a group (e.g., pointing out patterns or common challenge areas across classrooms) and any trends or other insights on any knowledge gaps or other information. This also enables insights for students to understand and assess their own knowledge.

Some embodiments relate to a computer-implemented system or platform comprising combinations of the following components and/or other components.

The platform may include the following feature: once a number of students have taught their characters about the topic, a competition module can manage competitions among the taught characters to provide further visual feedback to the students based on their characters' performance relative to the other characters.

The platform may include AI characters with customizable teachable agents for each learner.

The platform may also include a question management component, which may leverage a “question genius” and implement a process of managing questions and logic for generating and displaying questions for the teachable agents via the UI. In some embodiments, the question management component may involve using a large language model (LLM) along with a retrieval augmented generation (RAG) stack. As one example, the LLM may be any know LLM including for example, OpenAI's GPT-3.5, GPT-4 and/or other LLMs. The question management component, sometimes referred to herein as the question genius, generates questions for the teachable agent to answer and evaluates the quality of the agent's responses. The question genius may leverage the RAG stack to augment the LLM's capabilities by retrieving information from other systems and inserting them into the LLM's context window via a prompt. In the case of the question genius, this other information can be a variety of types of information in a variety of digital forms [generic term], such as a PDF (or other digital) version of a textbook, a web page source, an expansive vectorized database of the College Board's Advanced Placement curriculum and study materials and/other types and/or forms of information. The RAG may include information about specific topics and may be used to assist in generating questions on specific topics. The question genius in addition to obtaining content context to generate questions, also mediates the kind of question given to the user in other ways. Principally, it may incorporate varying kinds of questions based on the flow of the learning sequence. A user can select the level of difficulty of question they want the agent to encounter, and the question genius provides questions accordingly. Question difficulty may be guided by Bloom's taxonomy of learning, with easier questions corresponding to the lower levels of the taxonomy, and difficulty remaining proportional to the taxonomy. In addition, the question genius might also engage with the user's state and pose specific questions to encourage or challenge the user. Questions to challenge the user might focus on a user's knowledge gaps, while questions related to things they already know are easier and will encourage the user with a correct answer.

The platform may also include a UI component for generating user interfaces which display information to the student and with which the student can interact. As detailed below, the UIs may include a novel interface that includes a first portion for enabling an student to input explanatory material based on key learnings from resources associated with a learning topic, a second portion that displays information about questions/problems for the teachable agent to answer/solve and a third portion that displays the students AI character attempting to answer/solve the questions/problems so that the student can see the AI agent applying the knowledge it has been taught and to display questions or problems that AI agent has when answering/solving the questions/problems. Based on noted deficiencies in the AI agent's performance, the student can use the first display portion to enter additional explanatory information about the topic.

The platform may also include an activity log and various data collection and analytics tools. The data may be stored in one or more databases. The analytics may include algorithms for processing data to make determinations regarding conceptual understanding, persistence, user engagement, and/or other analytics to provide quantitative and/or graphical feedback about the progression of learning on an individual student basis and group basis (e.g., and entire class or some defined group of students). Some analytics may be displayed to a teacher to provide the teacher with insights for individual students or groups of students. Some analytics may be displayed to one or more students to provide data on the student's progress and focus areas.

The platform may also include a competition management component for managing competitions among the teachable agents. According to some embodiments, students may teach their agents about one or more topics and once sufficiently taught, the competition manager may manage competitions among the agents to determine which agents have been taught the best. This is another layer of feedback to the students as they see how they have performed compared to other students.

According to some embodiments, various methods may be implemented using the platform, including to enable a scalable implementation of applying recursive feedback to LBT. For example, the method may include a student selecting and customizing an agent (AI character). The method may also include training the agent(s) as detailed below. The method may also include the system displaying a UI to the student, which displays information to the student and with which the student can interact. As detailed below, a UI may include a novel interface that includes a first portion for enabling a student to input explanatory material and then a student entering explanatory material. Based on the entered material, the user's AI character (aka teachable agent) may learn about the material as detailed below. The displayed UI may also include a second portion that displays information about questions/problems for the teachable agent to answer/solve and a third portion that displays the student's AI character attempting to answer/solve the questions/problems so that the student can see the AI agent applying the knowledge it has been taught and to display questions or problems that AI agent has when answering/solving the questions/problems.

One aspect of the method of displaying information about questions/problems for the teachable agent to answer/solve includes operating the question management component to enable the system to select questions/problems to be displayed via the UI. Details of operation of the question management component are provided below.

Based on the AI character's performance in answering/solving the questions/problems, the user can assess what the AI character didn't learn or otherwise needs more information to about the topic. Via the first portion of the display, students may use recursive feedback to modify their explanation and deepen their agent's understanding.

Recursive Feedback relates to the concept of observing a pupil apply your teaching to refine your own conceptual understanding. In this system this is enabled through the technical features of the platform as described herein, where the student is teaching their agent and observing the agent apply their knowledge. The system also leverages the Protégé Effect which relates to principle that students often make greater effort to learn on behalf of others than themselves, leading to better academic performance. While these methods are generally known, they are hard to scale. The technology platform and of the invention provides a novel technical solution to apply and scale these concepts.

The platform is an interactive learning experience which helps users deepen, reinforce, and identify gaps in their knowledge by teaching an AI character. The platform leverages the proven learning-by-teaching (LBT) methodology, allowing students to teach what they're learning to the character—referred to here as a “teachable agent”—who plays the role of a novice.

Research in the LBT literature supports the efficacy of this approach in building two critical skills: metacognition, which is awareness about one's own understanding (Duran, 2017) and calibration (Bol & Hacker, 2012), which is the extent to which an individual's assessment of their own performance aligns with their actual performance. By teaching their agent and fielding the character's questions about the topic, users develop a better sense of what they know and do not know.

The platform's features are informed by findings from LBT research. The first phenomenon the product employs is the protégé effect (Chase et al., 2009). To invoke the protégé effect, we leverage a narrative game setting, in which the user is on a quest to help their agent gain skills and master material. The platform capitalizes on proven strategies for student engagement, including social exploration, competition, customization of virtual pets, and aiding characters in their growth and evolution.

Throughout the learning experience, the user watches the agent apply what it has learned to solve problems and answer questions. The character's performance provides the user with indirect feedback about their own understanding of the material. This design makes use of a second learning sciences phenomena known as recursive feedback (Okita & Schwartz, 2013), which is an ego-protective mechanism that helps the user stay motivated in their learning. Instead of putting the user in a position to receive direct feedback on their performance, which can be discouraging if they are struggling, the agent acts as a proxy for the user's understanding, safeguarding their morale while encouraging emotional investment.

In addition to helping students learn more effectively, the platform also allows teachers or tutors to more effectively identify where their students aren't grasping material. The platform illuminates student reasoning in addition to answers, showing educators exactly where their students are stuck and pointing out patterns or common challenge areas across classrooms.

The data the platform gathers can ultimately serve as a new form of formative assessment for educators, providing more instantaneous and valuable insights than a traditional exam.

The platform puts users in the role of a tutor, with the agent as the tutee, and guides them through a 3-part cycle; prepare; teach; observe. Users gather relevant information, explain concepts to their agent, and then watch their agent apply the information on practice problems, gaining insight into their own conceptual understanding based on the performance of the agent. This cycle repeats as the user, seeing the limitations of the agent's ability, returns to the preparation stage to gather and teach new information that the agent needs to succeed. The platform leverages the protégé effect and recursive feedback to drive student engagement and minimize discouragement during the learning experience. It measures success and impact through the following outputs:
Conceptual understanding: Measured by change in the agent's ability to answer questions and changes in the question level (mild, medium or spicy) at which the agent is competing;
Persistence: Measured by number of times a user returns to the preparation” and “teaching” stages when the agent gets something wrong;
User engagement: Measured by number of times a user returns to the platform and number of minutes they spend engaging with their agent.

Consistent access to feedback has a significant impact on academic performance. Social and educational inequality stratifies the access that students receive to quality feedback from teachers; shrinking school budgets and teacher shortages mean student access to feedback is increasingly hard to come by. Some students use practice products to remediate or extend learning, but the feedback delivered in existing products is typically limited to the binary right/wrong explanations that accompany multiple-choice examinations. Educational equity means ensuring that every student has access to an education that isn't just drilled into them, but rather provides an engaging experience that coaxes out their potential.

While many ed tech tools are leveraging AI to create bots that teach students, these efforts only maintain a submissive framework for education that does not invite students to take ownership in their learning experience. Students are locked into an experience where information is continuously delivered to them, and an algorithm isolates them into ‘adaptive’ practice that feels less like the ‘personalized’ learning experience these programs promise and more like ‘isolation.’

The platform's goal is to provide a platform where students, with the help of scaffolds, take ownership of their own learning. The teachable agent's performance provides highly-scalable recursive feedback, thereby allowing students to identify and eliminate learning gaps independently. This approach uses AI as a means to empower learners and mitigates the risks of validity and bias associated with the involvement of AI in education. In an instructional sense, we believe this tool will also empower teachers to dedicate their attention to areas of study with which all students are struggling, and to identify students who might need targeted personal.

According to some embodiments, various methods may be implemented using the platform, including to enable a scalable implementation of applying recursive feedback to LBT. For example, the method includes displaying, by one or more processors, a graphic user interface that includes a first portion configured to enable a user to create a knowledge graph for a learning module. The method may further include creating, by the one or more processors, the knowledge graph based on inputs received from the first portion of the graphic user interface. The method may further include selecting, by the one or more processors, one or more questions for a teachable agent to answer using the created knowledge graph. The method may further include in response to receiving answers for the one or more questions, generating, by the one or more processors, a real-time visualization of thought processes of the teachable agent.

### BRIEF DESCRIPTION OF THE DRAWINGS

FIG. 1 illustrates an example process in accordance with the embodiments disclosed herein.

FIG. 2A-2I illustrate example interfaces in accordance with the embodiments disclosed herein.

FIG. 3 illustrates an example flow in accordance with the embodiments disclosed herein.

FIG. 4 illustrates an example flow in accordance with the embodiments disclosed herein.

FIG. 5 illustrates an example flow in accordance with the embodiments disclosed herein.

FIG. 6 illustrates an example system in accordance with the embodiments disclosed herein.

FIG. 7 illustrates an example computer system in accordance with the embodiments disclosed herein.

FIG. 8 illustrates another example computer system in accordance with the embodiments disclosed herein.

FIG. 9 illustrates an example flow in accordance with the embodiments disclosed herein.

FIG. 10 illustrates an example flow in accordance with the embodiments disclosed herein.

FIG. 11 illustrates an example flow in accordance with the embodiments disclosed herein.

FIG. 12 illustrates an example flow in accordance with the embodiments disclosed herein.

FIG. 13 illustrates an example flow in accordance with the embodiments disclosed herein.

FIG. 14 illustrates an example flow in accordance with the embodiments disclosed herein.

The figures are not intended to be exhaustive or to limit the invention to the precise form disclosed. It should be understood that the invention can be practiced with modification and alteration and that the disclosed technology be limited only by the claims and the equivalents thereof.

### DETAILED DESCRIPTION

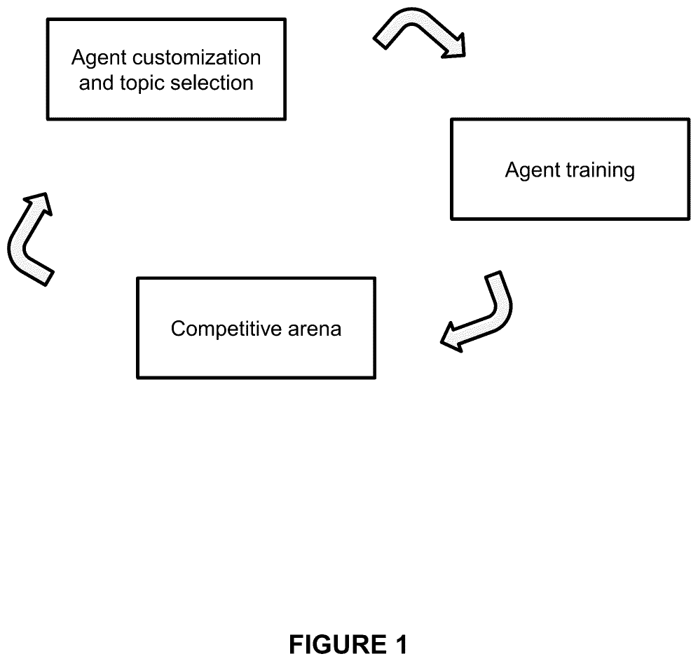

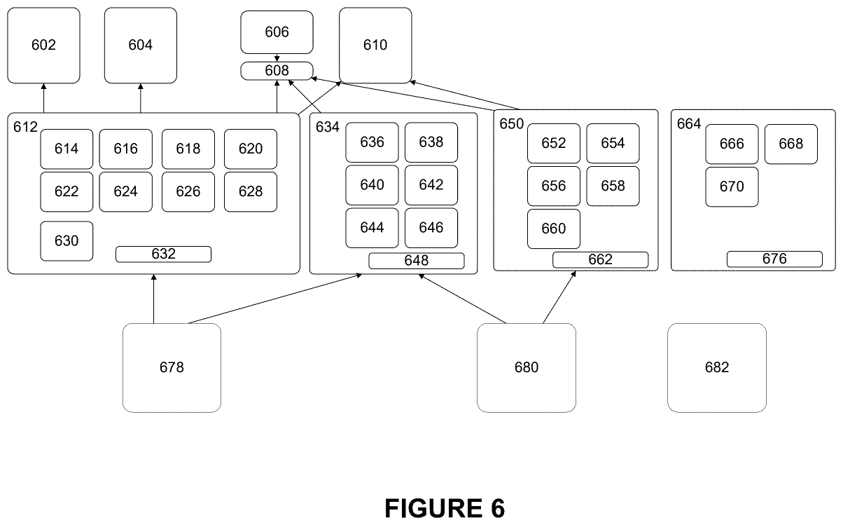

FIG. 1 illustrates an example process associated with the LBT computer platform according to various embodiments of the present disclosure. The various functions and features described with respect to FIG. 1 can, at least in part, be performed by or facilitated by a LBT computer platform, such as the system of FIG. 6. As illustrated in FIG. 1, the example process shows a general cycle of behaviors between users and agents. As illustrated in FIG. 1, the example process cycles between agent customization and topic selection, agent training, and competitive arena. Agent customization facilitates interactions between users and agents, including customization of the agents. For example, an agent customization area can be provided where a user can modify the appearance of an agent through addition or removal of outfits, accessories, and other objects. These objects, in some cases, can be provided as rewards (e.g., earned from the competitive arena) or purchased from a store (e.g., digital store). Other interactions between users and agents include communication between the users and agents and causing actions to be performed by the agents. For example, a user can type messages to an agent and receive responses to the messages. The user can cause the agent, for example through messages or selections, to perform various actions such as dance, sing, or tell a joke. Interactions between the users and the agents can build rapport between the users and the agents and encourage the users to further engage with the agents and use the LBT computer platform. Topic selection facilitates selection of a topic for a user to explain to an agent. Agent training facilitates learning of a topic by the user through the LBT techniques provided by the LBT computer platform. For example, a user can be prompted with a topic-level question and provide an explanation to an agent. The explanation can be evaluated to determine, for example, knowledge gaps of the user regarding the topic. Competitive arena facilitates demonstration of agent training through gameshows, matching activities, speed questions, and other competitive events. For example, an agent trained by a user can compete against premade bots or other agents trained by other users to demonstrate knowledge explained to the agent by the user. In this way, users are provided with an engaging demonstration of the knowledge explained to agents, which is indicative of the users' own knowledge.

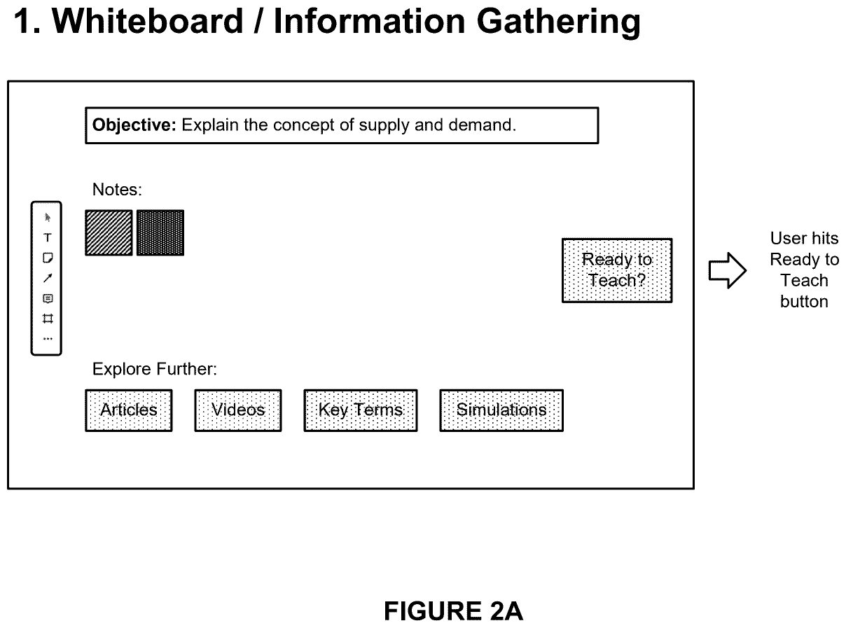

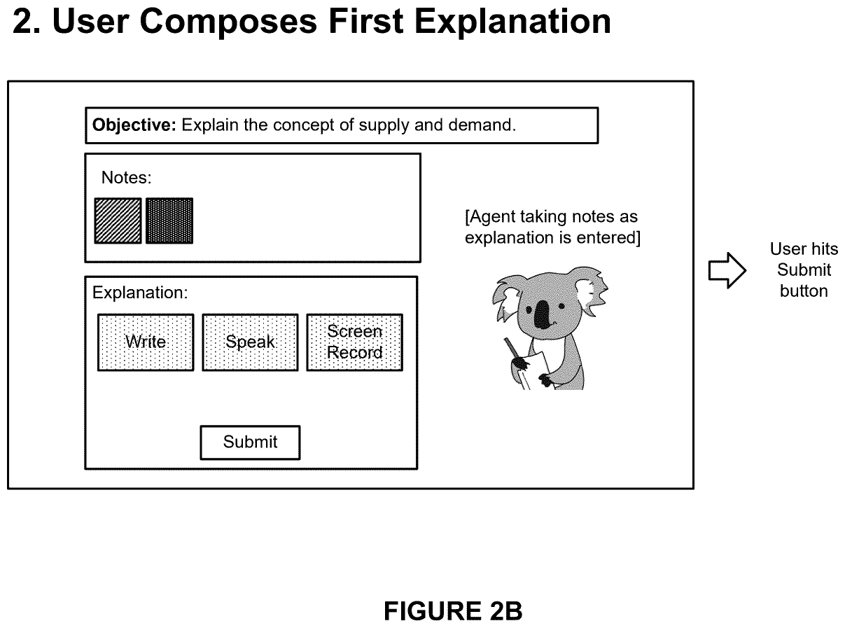

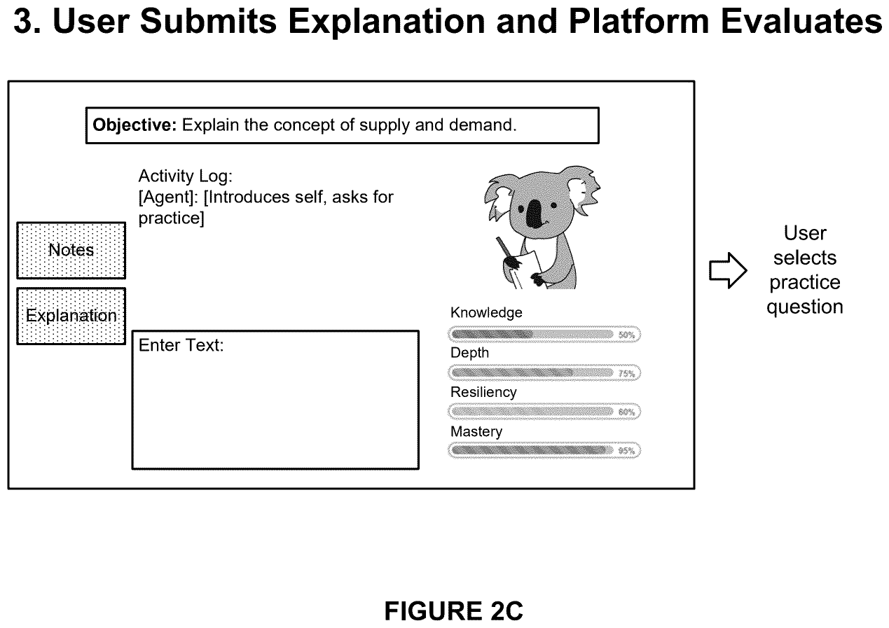

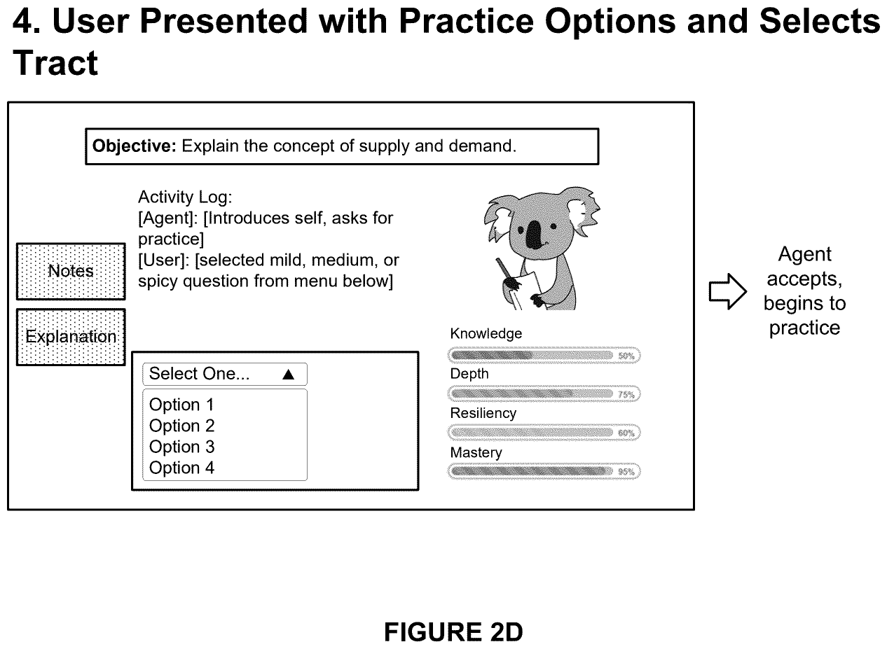

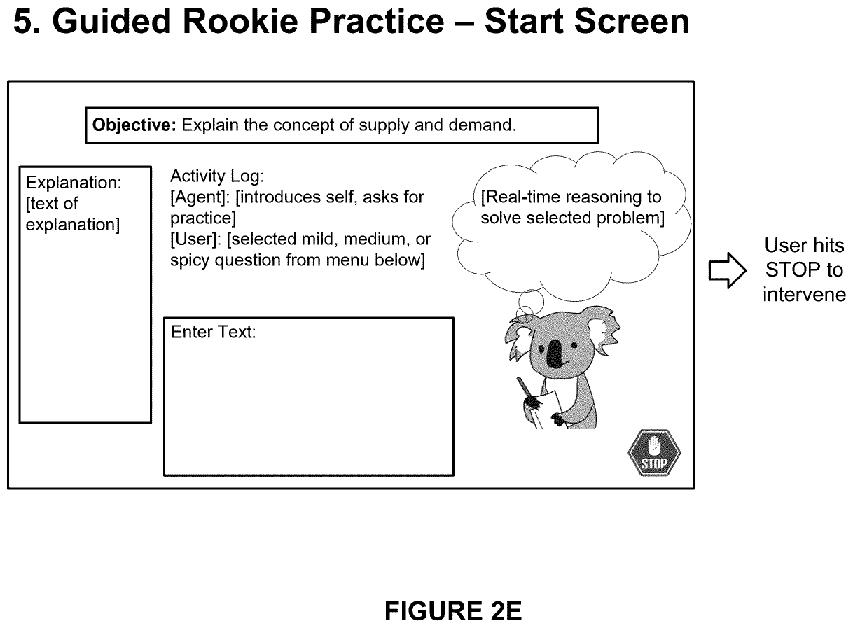

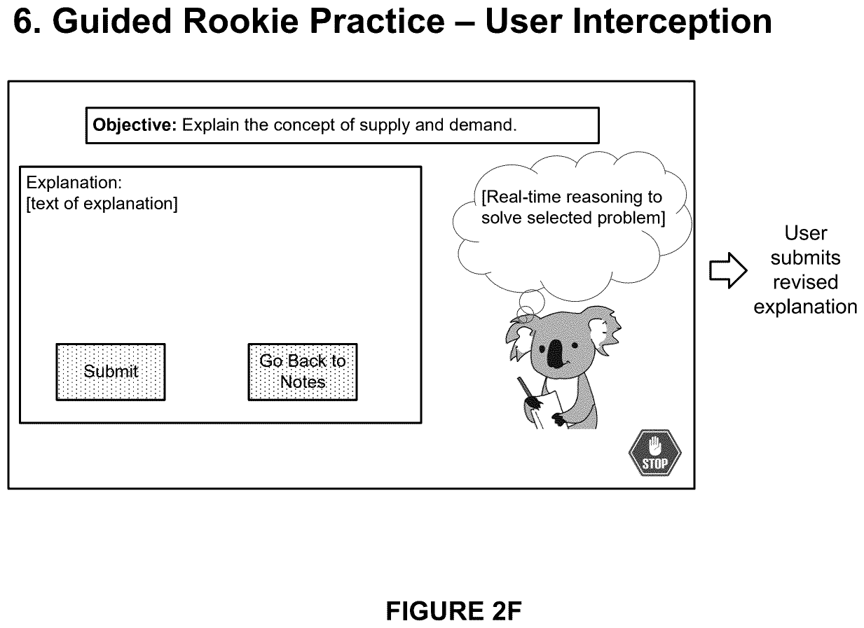

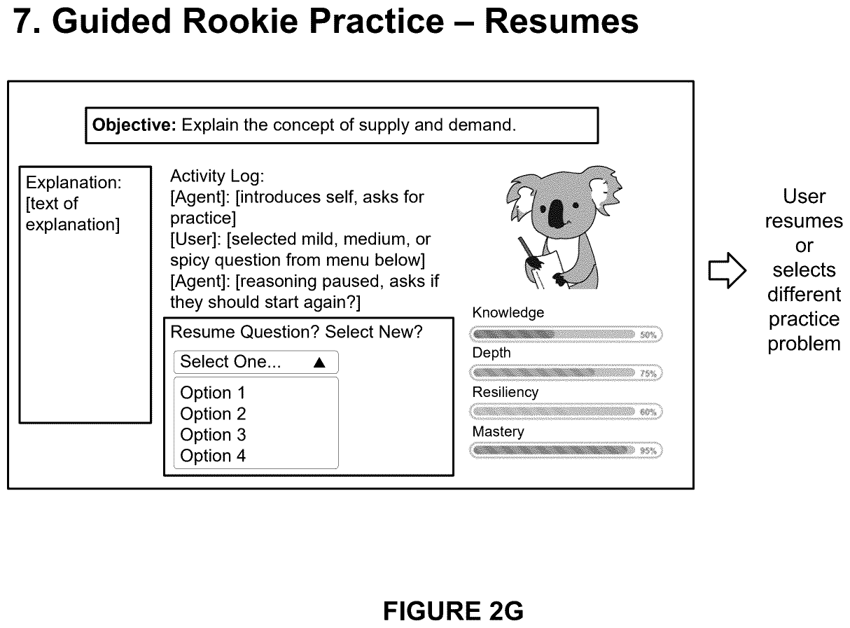

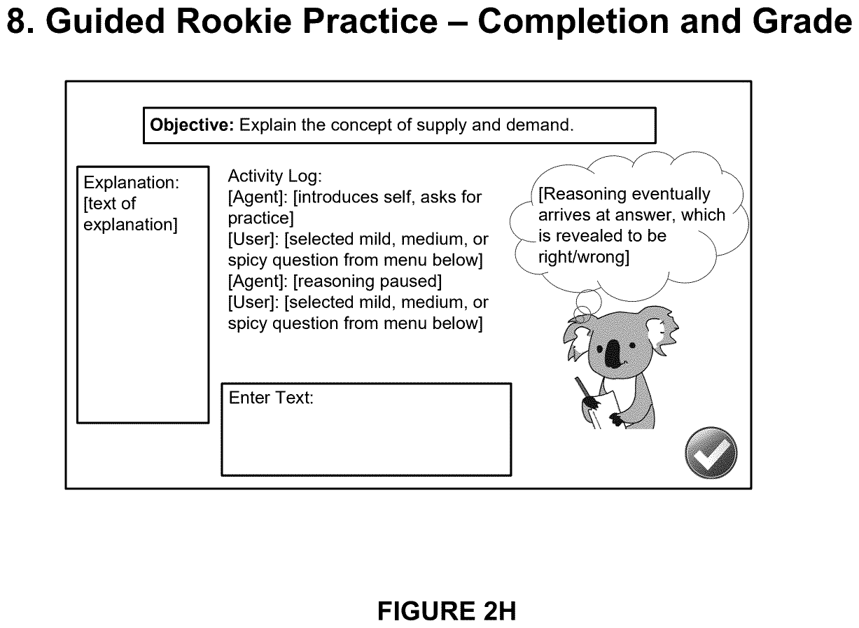

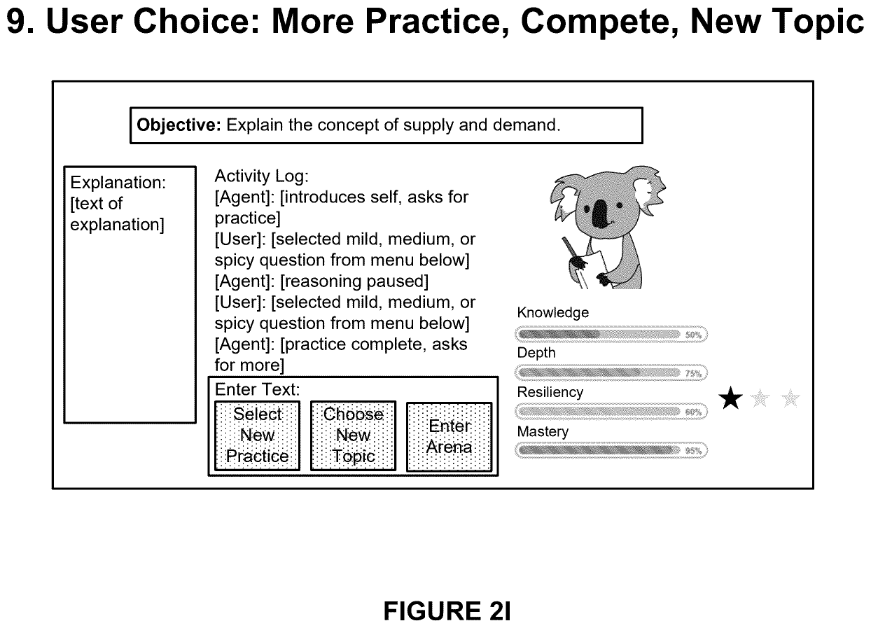

FIGS. 2A-2I illustrate example interfaces associated with the LBT computer platform according to various embodiments of the present disclosure. The various functions and features described with respect to FIGS. 2A-2I can, at least in part, be performed by or facilitated by a LBT computer platform, such as the system of FIG. 6.

FIG. 2A illustrates an interface for whiteboard/information gathering. As illustrated in FIG. 2A, the interface for whiteboard/information gathering can include a prompt (e.g., explain the concept of supply and demand) that provides a user with a topic to explain to an agent. Through the interface of FIG. 2A, users can begin composing their explanations, such as by preparing notes and engaging with articles, videos, key terms, simulations, and other content related to the topic. When the user is ready to begin teaching the agent, the user can select a button (e.g., “Ready to Teach?”) to begin the lesson.

FIG. 2B illustrates an interface for a user to compose a first explanation. The interface illustrated in FIG. 2B can be provided, for example, following an interaction with the interface of FIG. 2A. In FIG. 2B, the interface includes the prompt of the topic the user is to explain to the agent. The user can access notes prepared for the explanation of the topic. When the user is ready to begin the explanation, the user can select an option (e.g., write, speak, screen record) for providing the explanation to the agent. It should be understood that multiple options can be selected and other options not illustrated in FIG. 2B can be provided, such as an option for recording video. The user can select a button (e.g., “Submit”) to submit the explanation. Also illustrated in the interface is the agent (e.g., koala). The agent can perform various actions (e.g., take notes) to display engagement with the explanation.

FIG. 2C illustrates an interface for a user to submit an explanation that the LBT computer platform evaluates. The interface illustrated in FIG. 2C can be provided, for example, following an interaction with the interface of FIG. 2B. In FIG. 2C, the interface includes the prompt of the topic the user is to explain to the agent. The user can access notes prepared for the explanation of the topic. The user can access the explanation that was submitted for the topic. The interface includes an activity log that provides a log of activities performed by the agent (e.g., introduce self, ask for practice) and the user. The interface includes an area to enter text and send messages to the agent. For example, the user can ask questions related to the topic for the agent to answer. The interface includes evaluations of the explanation as determined by the LBT computer platform. In this example, the evaluations of the explanation is provided as progress bars indicative of the evaluations of the explanation (e.g., knowledge, depth, resiliency, mastery). Other techniques for providing evaluations are possible.

FIG. 2D illustrates an interface for a user to select practice questions or tracts. The interface illustrated in FIG. 2D can be provided, for example, following an interaction with the interface of FIG. 2C. In FIG. 2D, the interface includes the prompt of the topic the user is to explain to the agent. The user can access notes prepared for the explanation of the topic. The user can access the explanation that was submitted for the topic. The interface includes an activity log that displays activities performed by the agent (e.g., introduce self, ask for practice) and the user (e.g., select question). The interface includes an area for the user to select practice options, such as practice questions and different levels of difficulty.

FIG. 2E illustrates an interface for a user to begin a guided rookie practice process facilitated by the LBT computer platform. The interface illustrated in FIG. 2E can be provided, for example, following an interaction with the interface of FIG. 2D. In FIG. 2E, the interface includes the prompt of the topic the user is to explain to the agent and the explanation of the topic provided by the user. The interface includes an activity log that displays activities performed by the agent (e.g., introduce self, ask for practice) and the user (e.g., select question). In this example, the user has provided a practice question for the agent to answer, and the real-time reasoning to solve the practice question is displayed in the interface. The real-time reasoning can include corollary aspects of the explanation and highlight those aspects as they are leveraged during the real-time reasoning. During the real-time reasoning, the user can select a STOP button to intervene.

FIG. 2F illustrates an interface for a user to intercept real-time agent reasoning during a guided rookie practice process facilitated by the LBT computer platform. The interface illustrated in FIG. 2F can be provided, for example, following an interaction with the interface of FIG. 2E. In FIG. 2F, the interface includes the prompt of the topic the user is to explain to the agent and the explanation of the topic provided by the user. Here, the user can revise the explanation and submit a revised explanation. To facilitate revision of the explanation, the user can access notes prepared for the explanation of the topic. For example, the user can determine, based on the real-time reasoning of the agent, that the explanation provided to the agent is insufficient in some way and revise the explanation accordingly. Upon submission of the revised explanation, the agent can resume real-time reasoning based on the revised explanation.

FIG. 2G illustrates an interface for a user to resume real-time agent reasoning during a guided rookie practice process facilitated by the LBT computer platform. The interface illustrated in FIG. 2G can be provided, for example, following an interaction with the interface of FIG. 2F. In FIG. 2G, the interface includes the prompt of the topic the user is to explain to the agent and the explanation of the topic provided by the user. The interface includes an activity log that displays activities performed by the agent (e.g., introduce self, ask for practice, resume reasoning) and the user (e.g., select question). In this example, the interface includes options to resume a question after an explanation was revised or to select new practice questions. Furthermore, the interface can display updated evaluations based on the revised explanation. For example, the progress bars can increase in length if the revised explanation improves over the original explanation.

FIG. 2H illustrates an interface for a user to complete a guided rookie practice process facilitated by the LBT computer platform and receive a grade. The interface illustrated in FIG. 2H can be provided, for example, following an interaction with the interface of FIG. 2G. In FIG. 2H, the interface includes the prompt of the topic the user is to explain to the agent and the explanation of the topic provided by the user. The interface includes an activity log that displays activities performed by the agent (e.g., introduce self, ask for practice, resume reasoning) and the user (e.g., select question). In this example, the user has selected a new practice question after revising an explanation for the topic. The interface displays real-time reasoning performed by the agent with respect to the new practice question. Based on the real-time reasoning, the agent can answer the new practice question correctly or incorrectly. Here, the guided rookie practice process can be completed and a grade can be provided to the user based on the explanation provided. At this point, and at various points throughout the guided rookie practice process, the user can enter text and send messages to the agent to, for example, provide hints, provide encouragement, provide warnings, and provide remarks.

FIG. 2I illustrates an interface with various options for a user after a guided rookie practice process facilitated by the LBT computer platform. The interface illustrated in FIG. 2I can be provided, for example, following an interaction with the interface of FIG. 2H. In FIG. 2I, the interface includes the prompt of the topic the user is to explain to the agent and the explanation of the topic provided by the user. The interface includes an activity log that displays activities performed by the agent (e.g., introduce self, ask for practice, resume reasoning) and the user (e.g., select question). Here, the grade (e.g., stars) and the evaluations (e.g., progress bars) are provided to the user based on the explanation and/or revised explanation(s) provided by the user. In some cases, the grade (e.g., stars) can be based on a level of difficulty associated with the practice question provided. Rewards (e.g., powerups, agent customizations) can be earned based on the grade. With the guided rookie practice process completed, the user can be presented with options to select a new practice, choose a new topic, or enter a competitive arena. The user can, for example, select a new practice to initiate a guided rookie practice process (e.g., as illustrated in FIGS. 2D-2I), select a new topic to return to a menu or visual map of topics, or choose to enter a competitive arena. Many variations are possible.

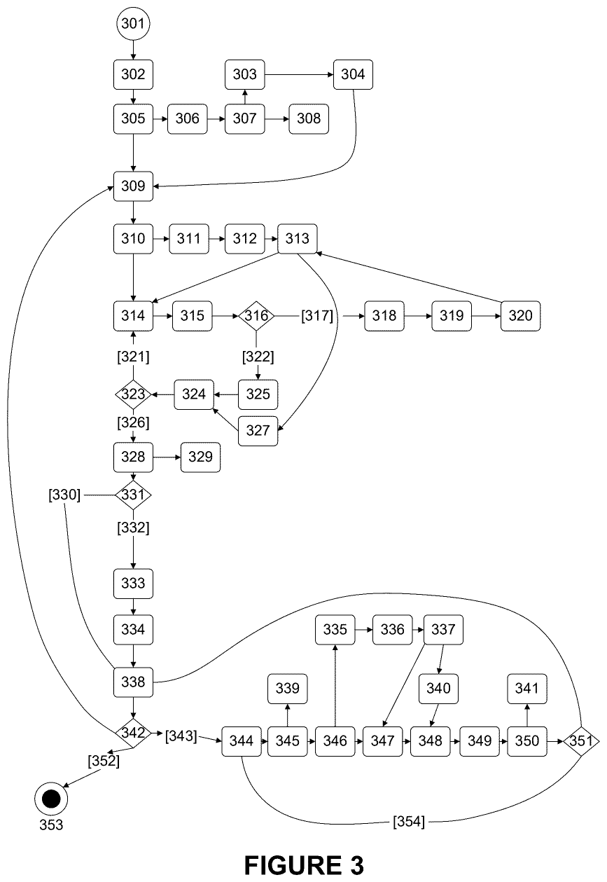

FIG. 3 illustrates an example flow associated with LBT techniques facilitated by the LBT computer platform according to various embodiments of the present disclosure. The various functions and features described with respect to FIG. 3 can, at least in part, be performed by or facilitated by a LBT computer platform, such as the system of FIG. 6. The example flow begins at 301. At 302, a learner (e.g., user) is prompted with a topic-level question (e.g., “How might someone perform a cost-benefit analysis?”). At 305, the learner answers the question. At 306, the learner's explanation is updated for the module in the instruction interaction store. At 307, the learner's knowledge gaps are identified. At 308, the learner's knowledge gaps for the module are updated in the student knowledge store. At 303, the learner's knowledge gaps are evaluated for progress towards the goal. At 304, the progress and question difficulty recommendation are updated. At 309, the learner suggests a level of difficulty for the questions. This can be an optional step, and a level of difficulty can be suggested by the LBT computer platform. At 310, the number of questions is set by the learner or the LBT computer platform. This can be an optional step. At 311, the learner's required question needs and knowledge gaps are obtained. At 312, relevant questions are generated for the agent to answer. At 313, answers and explanations based on the learner's knowledge gaps are generated. At 314, the agent is presented with a question. At 315, the agent provides their thinking. At 316, the flow proceeds to 318 if, at 317, the learner stops the agent's reasoning. At 316, the flow proceeds to 325 if, at 322, the learner performs no operations. At 318, the learner provides updates to the agent or the original explanation to account for a perceived gap or misunderstanding. At 319, the learner's knowledge gaps are identified. At 320, the learner's knowledge gaps for the module are updated in the student knowledge store. At 325, the agent submits answers to the question. At 324, the agent's answer is graded by the platform as right/wrong. The learner observes these graded answers. At 327, an evaluation of the agent's answers is performed for correctness. At 323, the flow proceeds to 314 if, at 321, the agent has more questions to answer. The flow proceeds to 328 if, at 326, the agent is done answering questions. At 328, the agent's overall performance on the entire practice is graded by the platform and the user receives points. At 329, the learner's progress on the module is updated. At 331, the flow proceeds to 333 if, at 332, the agent answered some questions incorrectly or wasn't given spicy (e.g., highest difficulty) questions. At 331, the flow proceeds to 338 if, at 330, the agent was successfully answering all questions and some of them were spicy (e.g. highest difficulty). At 333, the learner is prompted to update their explanation and engage with learning materials. At 334, the explanation is opened for edits. At 338, the learner is prompted to try another round of questions, pick a new topic, or enter the arena (if ready). At 342, the flow proceeds to 344 if, at 343, the learner enters the arena. At 342, the flow proceeds to the end 353 if, at 352, the learner picks a new topic. At 344, the learner and agent enter the arena. At 345, the lobby is filled with agent opponents. Agent opponents can come from other students, or from premade bots. At 339, the agents are acquired from the agent store to compete against. At 346, the learner selects an event for the agent to compete in (e.g., gameshow, matching activity, speed questions). At 335, the learner's required question needs and knowledge gaps are obtained. At 336, relevant questions are generated for the agent to answer. At 337, answers and explanations based on the learner's knowledge gaps are generated. At 347, the agent completes the event. At 340, an evaluation of the agent's answers is performed for correctness. At 348, the event is scored. At 349, an option to click into the thinking to see where the losing agent went wrong is provided. Functions associated with this option can be performed, for example, by an answer evaluator that performed the evaluation of the agent's answers at 340. These functions can be performed, for example, by the learning experience backend 612 and the instructor insights backend 650 of FIG. 6. At 350, the learner receives points/stars/exp based on agent performance. At 341, a reward system is updated. At 351, the flow proceeds to 338 or the flow proceeds to 344 if, at 354, the learner selects to continue in the arena.

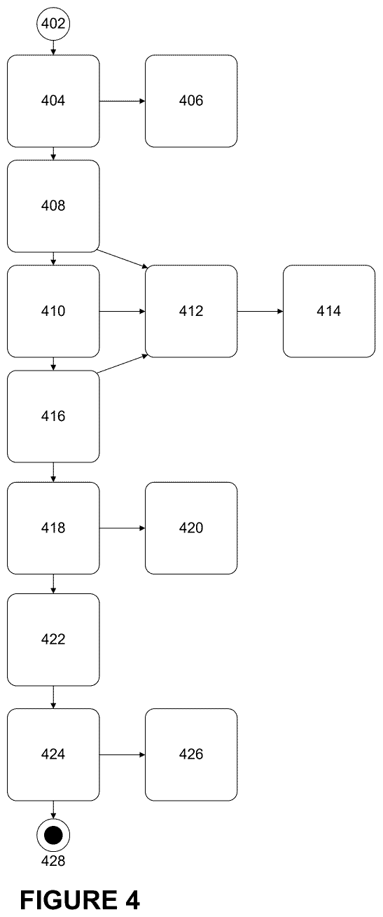

FIG. 4 illustrates an example flow associated with content creation (e.g., generation of new modules) facilitated by the LBT computer platform according to various embodiments of the present disclosure. The various functions and features described with respect to FIG. 4 can, at least in part, be performed by or facilitated by a LBT computer platform, such as the system of FIG. 6. The example flow begins at 402. At 404, a content creator wants to create a new module to add to a set of existing modules. At 406, a draft module is created. At 408, the creator specifies a topic, title, and topic question. At 410, the creator adds as much strict definition of mastery as possible. At 416, the creator adds as much contextual information to prepare the model. At 412, those fields (e.g., topic, title, topic question, definition of mastery, contextual information) are updated on the module. At 414, a set of fact statements is generated to form the rubric for the module. This set of fact statements is what explanations are verified against. At 418, the creator chooses the module settings for difficulty, completion, and progress. At 420, those fields (e.g., difficulty, completion, progress) are updated on the module. At 422, the creator specifies materials for the whiteboarding (e.g., pre-module) phase. At 424, the creator publishes the module as part of the learning context. At 426, the draft module object is copied into the published index, going live. The example flow ends at 428.

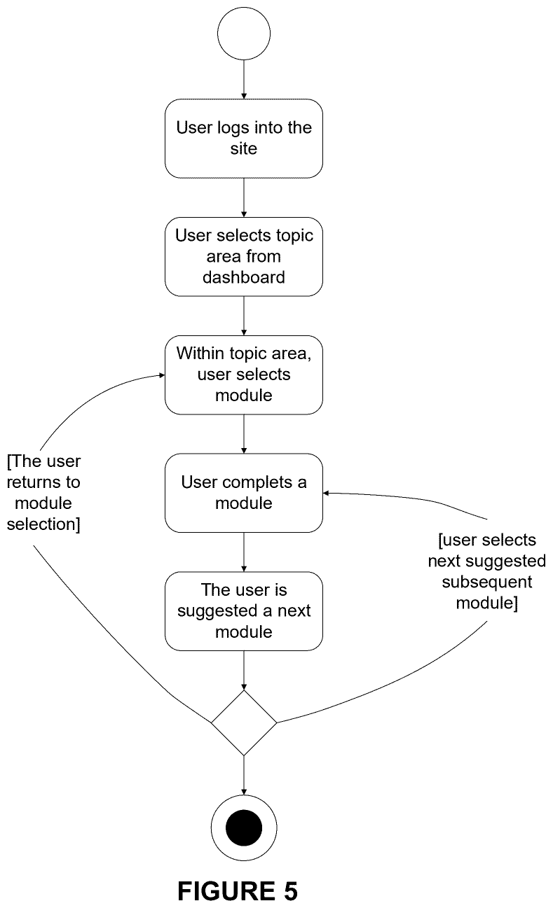

FIG. 5 illustrates an example flow associated with how learners (e.g., users) select which content they want to view using the LBT computer platform according to various embodiments of the present disclosure. The various functions and features described with respect to FIG. 5 can, at least in part, be performed by or facilitated by a LBT computer platform, such as the system of FIG. 6. The example flow begins, and a user logs into the site. Then, the user selects a topic area from a dashboard. Then, within the topic area, the user selects a module. Then, the user completes the module. Then, the user is suggested a next module. Then, the user can select a next suggested subsequent module and complete the module. Or, the user can return to module selection within the topic area and select a new module. This can repeat until the example flow ends.

FIG. 6 illustrates an example system including the software components of the LBT computer platform and the highest level interactions between the software components. As illustrated in FIG. 6, the example system includes infrastructure components comprising a fine-tuned models framework 602 (e.g., a collection models, each tuned to a specific set of modules), a portioned vectorized data store for module content 604, an RDS 606, and a LLM 610 as a service. The RDS 606 communicates with an object-relational mapping API 608. The system includes a learning experience backend 612 that communicates with the fine-tuned models framework, the portioned vectorized data store for module content 604, the object-relational mapping API 608, and the LLM 610. The learning experience backend 612 includes a module state class/sub-application 614, a module settings class/sub-application 616, an arena settings class/sub-application 618, an arena state class/sub-application 620, a learner knowledge class/sub-application 622, a questions class/sub-application 624, a progress class/sub-application 626, an answers and explanations class/sub-application 628, a white board apps class/sub-application 630 (e.g., pre-module learning materials), and learning handlers REST APIs 632. In general, the learning experience backend 612 manages navigation, state progress, and grading for learners with respect to a module. The system includes a learner management backend 634 that communicates with the object-relational mapping API 608. The learner management backend 634 includes an enrollment class/sub-application 636, an avatars/rewards class/sub-application 638, a user class/sub-application 640, a roles class/sub-application 642, an LTI provider app class/sub-application 644, a permissions class/sub-application 646, and REST APIs 648. The system includes an instructor insights backend 650 that communicates with the object-relational mapping API 608 and the LLM 610. The instructor insights backend 650 includes a specific learner analysis class/sub-application 652, which determines the knowledge gaps that a student has, a bulk learner analysis class/sub-application 654, which determines trends in a cohort of users, an artifacts of assessment viewer class/sub-application 656, a mastery overview class/sub-application 658, a lesson plan generator class/sub-application 660, and REST APIs 662. The system includes a content creation backend 664. The content creation backend 664 includes a structure storage/versioning class/sub-application 666, a content upload/generation class/sub-application 668, a whiteboard app editing class/sub-application 670, and REST APIs 676. The system includes a learning experience frontend 678 that communicates with the learning experience backend 612 and the learner management backend 634. The system includes an instructor insights frontend that communicates with the learner management backend 634 and the instructor insights backend 650. The system includes a course creator frontend that communicates with the content creation backend 664.

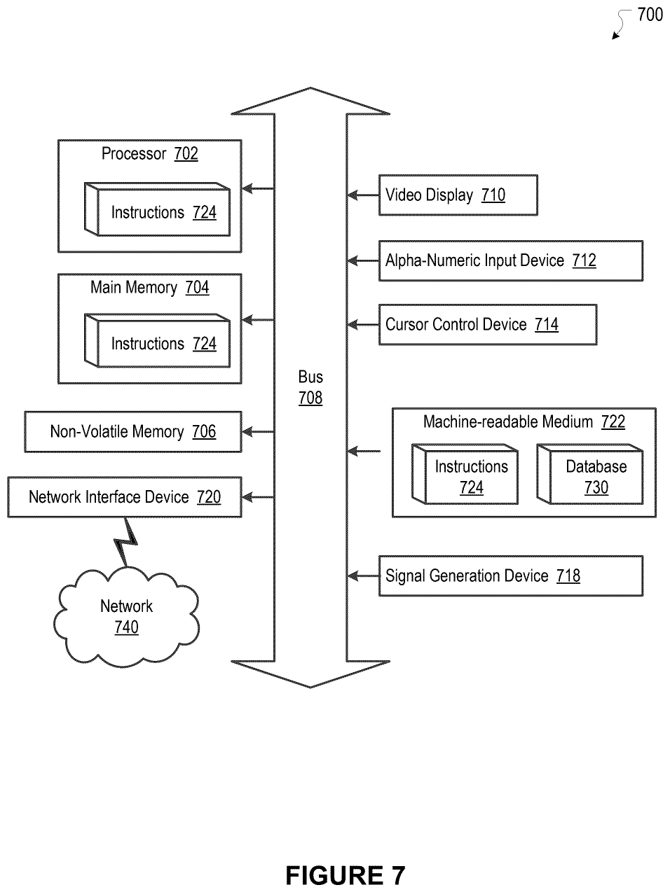

The foregoing processes and features can be implemented by a wide variety of machine and computer system architectures and in a wide variety of network and computing environments. FIG. 7 illustrates an example computer system 700 within which a set of instructions for causing the computer system to perform one or more of the embodiments described herein can be executed, in accordance with an embodiment of the present technology. The embodiments can relate to one or more systems, methods, or computer readable media. The computer system may be connected (e.g., networked) to other systems. In a networked deployment, the computer system may operate in the capacity of a server or a client system in a client-server network environment, or as a peer system in a peer-to-peer (or distributed) network environment.

The computer system 700 includes a processor 702 (e.g., a central processing unit (CPU), a graphics processing unit (GPU), or both), a main memory 704, and a nonvolatile memory 706 (e.g., volatile RAM and non-volatile RAM, respectively), which communicate with each other via a bus 708. The processor 702 can be implemented in any suitable form, such as a parallel processing system. In some instances, the example computer system 700 can correspond to, include, or be included within a computing device or system. For example, in some embodiments, the computer system 700 can be a desktop computer, a laptop computer, personal digital assistant (PDA), an appliance, a wearable device, a camera, a tablet, or a mobile phone, etc. In one embodiment, the computer system 700 also includes a video display 710, an alphanumeric input device 712 (e.g., a keyboard), a cursor control device 714 (e.g., a mouse), a signal generation device 718 (e.g., a speaker) and a network interface device 720.

In one embodiment, the video display 710 includes a touch sensitive screen for user input. In one embodiment, the touch sensitive screen is used instead of a keyboard and mouse. A computer-readable medium 722 is used to store one or more sets of instructions 724 (e.g., software) embodying any one or more of the methodologies or functions described herein. The instructions 724 can also reside, completely or at least partially, within the main memory 704 and/or within the processor 702 during execution thereof by the computer system 700. The instructions 724 can further be transmitted or received over a network 740 via the network interface device 720. In some embodiments, the computer-readable medium 722 also includes a database 730.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 706 may also be a random access memory. The non-volatile memory 706 can be a local device coupled directly to the rest of the components in the computer system 700. A non-volatile memory that is remote from the system, such as a network storage device coupled to any of the computer systems described herein through a network interface such as a modem or Ethernet interface, can also be used.

While the computer-readable medium 722 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the computer system 700 and that cause the computer system 700 to perform any one or more of the methodologies of the present technology. The term “computer-readable medium” shall accordingly be taken to include, but not be limited to, solid-state memories, optical and magnetic media, and carrier wave signals. The term “storage module” as used herein may be implemented using a computer-readable medium.

In general, routines executed to implement the embodiments of the invention can be implemented as part of an operating system or a specific application, component, program, object, module, or sequence of instructions referred to as “programs” or “applications”. For example, one or more programs or applications can be used to execute any or all of the functionality, techniques, and processes described herein. The programs or applications typically comprise one or more instructions set at various times in various memory and storage devices in the computer system 700 and that, when read and executed by one or more processors, cause the computer system 700 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a computer-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of computer-readable media used to actually effect the distribution. Examples of computer-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, “in various embodiments,” or the like means that a particular feature, design, structure, or characteristic described in connection with the embodiment is included in at least one embodiment of the disclosure. The appearances of, for example, the phrases “according to an embodiment”, “in one embodiment”, “in an embodiment”, “in various embodiments”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Embodiments of the present invention further recognize that existing online learning platforms may have compatibility issues with different operating systems, devices, and applications. Further, user interfaces of these online learning platforms can be complex and not always user-friendly. Often, these systems lack the capability to facilitate spontaneous and interactive discussions. In some instances, these online learning platforms lack capabilities to ensure the integrity and fairness of assessments conducted online. As mentioned above, traditional practice and assessment solutions typically do not give sufficient insight into student thinking. Students struggle to identify what they do not know, making it hard to know exactly what to study. Teachers often lack visibility into student reasoning, making it hard to know exactly where and why things might have gone wrong. For example, with multiple choice tests, all teachers see is an answer, not how the student thought about choosing the answer. Finally, these systems, designed with one-on-one touring struggle with scaling effectively with increased user demand.

Existing practice, assessment, and tutoring tools suffer from various technical limitations that result in a failure to strike a balance between engagement and efficacy. One-on-one tutoring can help with these problems, but often schools are resource-constrained and this is not a viable option. Nor is this approach scalable. Many edtech solutions overly rely on multiple choice questions. It is difficult for teachers to understand a student's reasoning when answers are multiple choice. Some learning solutions focus more on student engagement and personalized algorithms. Some emerging AI solutions subjugate students to passively ‘learn’ from a chat bot, that teaches the student, and dictates the pace and direction of learning, depriving students of a sense of agency.

Some embodiments of the present invention address these technical limitations commonly associated with online learning systems by allowing students to create a knowledge graph comprising nodes (representing topics or ideas) and edges (e.g., assignable connections with user provided descriptive text that explain the connection between nodes), the learn by teaching (LBT) computer platform significantly enhances engagement and interactivity. This dynamic structure overcomes the traditional limitation of limited interaction and engagement by providing an innovative method for students to actively participate in their learning process.

Some embodiments of the present invention address gaps in learning with the LBT computer platform that actively engages students to teach a responsive AI-powered “teachable agent.” By connecting topics on concept maps and explaining challenging ideas to the teachable agent, students reinforce their knowledge, uncover gaps, and build vital critical thinking skills. In this manner, the LBT computer platform integrates a teachable AI agent that utilizes the knowledge graph to answer teacher provided questions to assess the AI agent's “knowledge”, and by extension, the student's knowledge. Embodiments of the present invention can further provide a visual representation of the AI agent's thought process via a graphic user interface which highlights nodes and connections used to generate responses, thereby enhancing user interface simplicity and clarity.

Embodiments of the present invention are integrated into a practical application by providing a robust framework for students to learn by teaching the AI agent. The knowledge graph serves as a scaffold for organizing information, promoting a deeper understanding of subject matter through active engagement. The graphical user display, which visually represents the Al's reasoning process, not only aids in comprehension but also demystifies AI decision-making, making it accessible to students. Additionally, the LBT computer platform's scalability is enhanced through cloud-based architecture, which can efficiently handle increased user demand without compromising performance. This ensures that the system remains responsive and reliable, even during peak usage periods.

As discussed in greater detail below, embodiments of the present invention provide technical improvements by enhancing interactivity, ensuring software compatibility, and offering a transparent and engaging learning experience. Doing so fosters an environment where students can actively contribute to their learning, supported by a secure and scalable technological framework.

In one embodiment, the LBT computer platform can be integrated with large language models allows for a teachable agent to reason with the knowledge that it has been taught in a complex and nuanced way, on any content, for any question. This integration allows for scaling and adapting the teachable agent to any content area, and enables teachers to spend less time creating content. Through the data captured, embodiments of the present invention can analyze the student's granular step by step process as they go about teaching the agent. Doing so allows for the collection of previously difficult data to obtain and quantify-data indicative of a student's reasoning process. Accordingly, embodiments of the present invention can pinpoint inaccuracies and failures, and deliver this data as actionable insights for the educator, allowing them to remediate with increased efficiency, again improving the experience of the student. Over time, student engagement with embodiments of the present invention can develop students' critical thinking skills like metacognition and the ability to predict their own success. Embodiments of the present invention provide an accurate formative assessment for teachers will allow them to hone in on more effective teaching, leading to better educational outcomes.

This embodiment functions as a web app that integrates with learning management systems, providing a seamless experience in classrooms or self-study. This enables educators to upload curriculum and automatically generate a “perfect” knowledge map for each topic. This map is modified into an incomplete version, which becomes the basis of the student learning activity.

This embodiment includes a teachable agent, a graphical user interface having one or more portions configured to upload content and assess a user's knowledge, and a concept mapping tool. For example, in this embodiment, the teachable agent is an artificial intelligence character that learns from the student. Students create “knowledge maps” to teach the teachable agent. The teachable agent can then apply this knowledge to solve problems or answer questions. The process provides students with an intuitive, structured way to assess and refine their own understanding. Unlike peer teaching, the teachable agent mirrors only the student's input, avoiding the introduction of external misconceptions.

The graphical user interface configured to upload content allows users (e.g., teachers and instructors) to make modules for their students. When instructors upload curriculum materials (e.g., textbook excerpts, multimedia) into the graphic user interface (e.g., a dashboard), the LBT platform extracts, segments, and organizes this material into ideal structured knowledge maps. These maps form the source of truth against which teachable agent, and by proxy the student, is evaluated. This human-in-the-loop content creation process allows instructors to make the content they want in a way that is both easy and of high quality. The dashboard also offers real-time analytics, enabling instructors to monitor individual and class-wide progress.

In this embodiment, the concept mapping tool enables students to build knowledge maps by connecting “nodes” (i.e., key concepts) with “connections” (i.e., relationships such as “causes” or “leads to”). For example, a biology student can link terms such as “photosynthesis”, chloroplast,” and “carbon dioxide” to build a coherent map” This process encourages deep engagement and helps students deconstruct complex topics into manageable components.

This embodiment further includes gamified, engagement features depicted in a graphic user interface. For example, in one embodiment, the graphic user interface can depict a virtual space configured to enable students to test their knowledge. In one example, the graphic user interface can display can show the teachable agent answering questions derived from the instructor using the student created concept maps. In another example, the graphic user interface can depict an arena like environment that users can challenge the teachable agent's knowledge in a competitive of collaborative tests based on content the user (e.g., student) has taught. In another embodiment, the graphic user interface can be configured to perform skill calibration to enable students to hone their metacognitive skills. For example, in this embodiment, students can guess or wager on the teachable agent's performance. In yet another embodiment, the graphic user interface can be configured to display points earned in the virtual space (e.g., the arena) to personalize the teachable agent's appearance.

In this embodiment, the platform puts users in the role of a tutor, with the agent as the tutee, and guides the student through a multi-part cycle: teach, observe, revise. Users teach the teachable agent by building a concept map that reflects their understanding of a topic the user has just learned. For example, in a science unit on photosynthesis, students link nodes such as “chloroplast,” “light-dependent reactions,” and “ATP synthesis.” This structured activity lowers the barriers to teaching, turning instruction into a manageable process.

After observing the teachable agent's performance in answering questions based on the student's map, the student can identify gaps or inaccuracies in their teaching. In this embodiment, the teachable agent searches the map. The student watches the teachable agent search the student created knowledge map, extract relevant information, then combine that information into an answer. Unlike a human peer, who might introduce their own misconception, the teachable agent shows only the teaching student's missteps, as this reasoning reflects the student's exact input.

The LBT platform can then grade the teachable agent's answer against the instructor's ideal knowledge map created in the dashboard for instructors, providing targeted feedback to improve the student's concept map. The LBT platform provides feedback toward the teachable agent, not the student, reducing emotional discouragement and highlighting learning gaps. Students revise iteratively, deepening their understanding. When stuck, they access the teachable agent's resources such as a learning lounge interface that displays resources from instructors, curriculum, partners, and the LBT platform. The module ends when the teachable agent succeeds, signaling the student's teaching success.

For example, teachers use the dashboard to upload a curriculum on photosynthesis and create ideal knowledge maps for the teachable agent to be evaluated against. The students can engage in the multi-part cycle: teach, observe, revise. For example, after the lesson on photosynthesis, students can use the LBT platform to create a knowledge map linking to the teachable agent to develop connections between concepts like chlorophyll, light energy, and glucose production (e.g., teach phase). Students can observe as the teachable agent answer questions provided by the instructor. For example, as the teachable agent answers, the teachable agent provides visual cues indicating which nodes and connections were relied on to answer the question. This visual cue allows the student to identify incomplete or missing links between nodes. Based on this feedback, student can revise their maps by adding details and improving connections such as the role of ATP in energy transfer. Students can then present graphic user interfaces to test the student's knowledge. For example, in one embodiment, the graphic user interface can depict a virtual space configured to enable students to test their knowledge. In one example, the graphic user interface can display can show the teachable agent answering questions derived from the instructor using the student created concept maps. The graphic user interface can display points earned in the virtual space (e.g., the arena) to personalize the teachable agent's appearance. The LBT computer platform can then measure changes in metacognitive awareness as measured by pre and post surveys and an improvement in test scores.

In this manner, the LBT platform enables the generation, storage and processing of unique data to quantitatively assess and graphically display novel insights, including insights for the teacher into how a student is thinking (individually) or as a group (e.g., pointing out patterns or common challenge areas across classrooms) and any trends or other insights on any knowledge gaps or other information. This also enables insights for students to understand and assess their own knowledge.

In this embodiment, the LBT platform provides the following additional features: 1) screen reader compatibility, keyboard navigation, and alternative inputs for visual and mobility impairments; 2) adjustable font sizes and color contrast settings; 3) text-to-speech, closed captions, and alt text for multimedia to support auditory challenges; 4) multilingual tools for translation and text-to-speech; and 5) customizable controls for those with sensory needs.

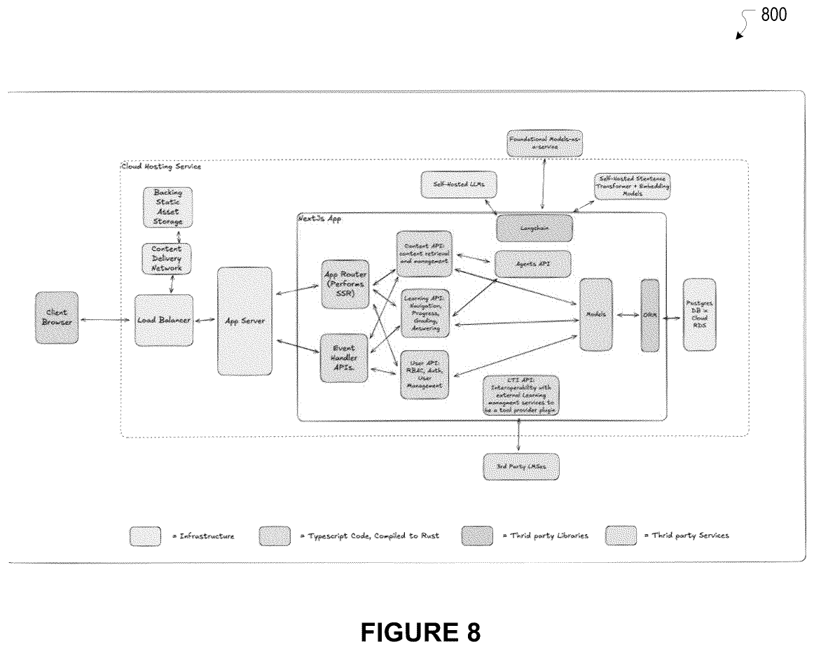

FIG. 8 illustrates another example computer system in accordance with the embodiments disclosed herein.

Example computer system 800 is representative of an embodiment of the LBT computer platform. In this example, the LBT computer platform is hosted on a cloud hosting service. Cloud hosting services as used herein refer to the provision of computing resources, such as servers, storage, databases, networking, software, and analytics, over the internet. These resources are offered by cloud service providers and allow users to host applications, websites, and other services without the need for physical infrastructure. Cloud hosting is scalable, flexible, and often more cost-effective compared to traditional hosting methods.

In this example, NextJs App (i.e., the LBT platform including the teachable agent) includes one or more application program interfaces to interact with one or more software applications (e.g., content API, learning API, user API, LTI API, and agents API).

The NextJsApp further includes an app router. The app router is a component in a web application responsible for directing incoming requests to the appropriate handler or view. In this embodiment, the app router performs Server Side Rendering (SSR) to handle requests and rendering the necessary components on the server before sending the complete HTML to the client.

The NextJs App further includes event handler APIs which are interfaces provided by software frameworks or libraries that allow developers to define and manage responses to events. Events as used herein refer to actions or occurrences, such as user interactions, system changes, or messages from other programs, that a program can detect and respond to. Event handlers are the functions or methods that execute in response to these events.

The app router and event handler APIs can interact with the content API to route requests for content retrieval and management (e.g., education content, lessons, modules, sources of ground truth, key concepts, etc.) and update based on user interactions. The app router and event handler APIs can interact with the learning API (e.g., to retrieve modules, sources of truth, knowledge graphs, and receives updates on how content is used and interacted with). The app router and event handler APIs can further interact with the user API to apply role-based access control to manage who can access or modify content (e.g., instructor versus student).

The app router and event handler APIs can further interact with an application server to direct incoming requests to the appropriate application server based on routing rules and logic. This ensure the correct application code is executed to generate the desired response. In this embodiment, the app router works with the load balancer to ensure that requests received from a client browser are efficiently distributed, preventing any single server from being overwhelmed and optimizing resource use. The app router can route requests for static assets in the content delivery network to ensure users receive assets from the closest content delivery node. Finally, the app router can retrieve static assets from backing static asset storage when needed, routing them through a content delivery network for optimized delivery.

The NextJs App further includes a fine-tuned models framework (e.g., a collection models, each tuned to a specific set of modules) that can communicate with Object-Relational Mapping (ORM) to convert data between incompatible systems using object-oriented programming languages. This allows the NextJs App to communicate with a Postgres database with a Cloud Relational Database Service (RDS). This setup provides the benefits of PostgreSQL's advanced database features along with the convenience and scalability of a managed cloud service.

The NextJsApp further includes Langchain which is a framework designed to build applications around large language models (LLMs). It facilitates the development of applications that can perform tasks such as language understanding, text generation, and more complex operations by leveraging capabilities of LLMs and provides a structured approach to integrate LLMs into various applications to make it easier to handle complexities involved in using these models effectively. The Langchain framework can interact with self-hosted LLMs, foundational models as a service, and self-hosted sentence transformer and embedding models.

The NextJs App further includes a Learning Tools Interoperability (LTI) API to facilitate the integration of external educational tools and platforms with learning management systems and can integrate one or more third party large language models using the LTI standard to communicate seamlessly, providing a consistent and secure user experience by standardizing the way data and functionality are shared.

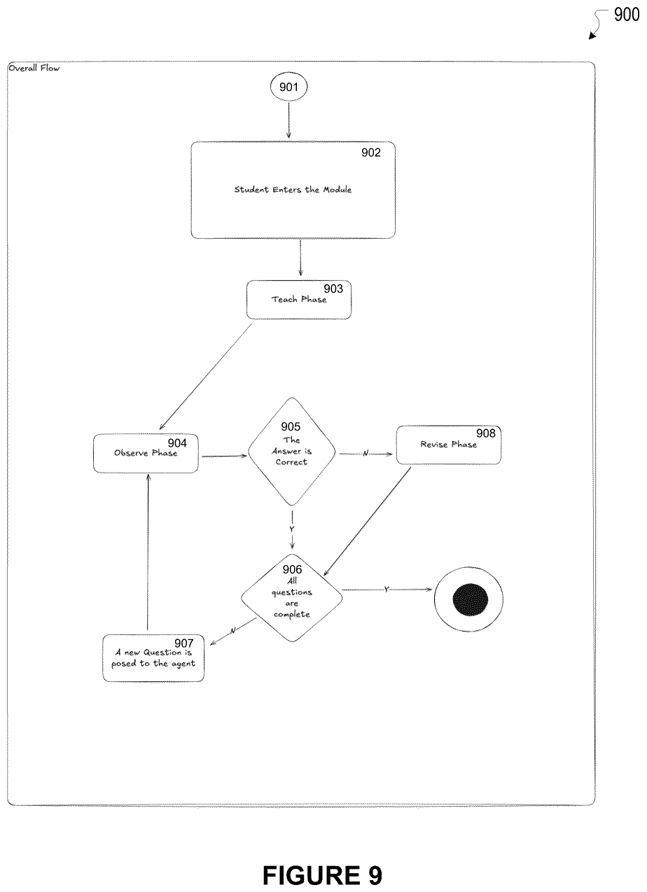

FIG. 9 illustrates an example flow associated with an overall flow representing techniques facilitated by the LBT computer platform according to various embodiments of the present disclosure. The various functions and features described with respect to FIG. 9 can, at least in part, be performed by or facilitated by a LBT computer platform, such as the system of FIG. 8.

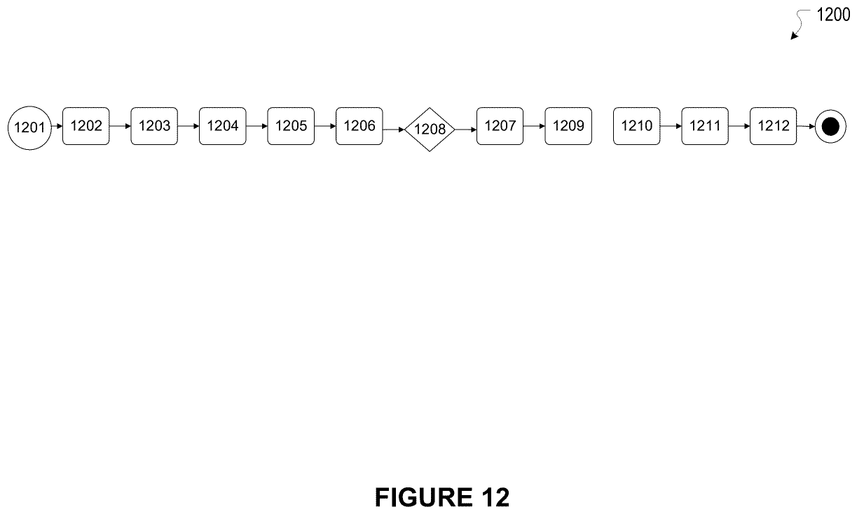

The example flow begins at 901. In step 902 where the LBT computer platform presents and subsequently displays a user with a graphic user interface including a first portion configured to enable a student to enter a learning module. At 903, the LBT computer platform presents a user with a graphic user interface configured to allow a user to begin the teach phase. The LBT computer platform creates a knowledge graph based on inputs provided by the student in the first portion of the graphic user interface. In step 904, the LBT computer platform presents a user with another portion of the graphic user interface configured to allow a user to begin the observe phase. In this way, the LBT computer platform can display a real-time visualization of thought processes of the teachable agent as discussed in greater detail with respect to FIG. 12. At step 905, the LBT computer platform determines whether the teachable agent answers the question correctly. If, in Step 905, the LBT computer platform determines that the teachable agent answered correctly, the LBT computer platform determines whether all questions are complete in step 906.

If, in step 906, the LBT computer platform determines that all questions are complete, then processing ends. If, in step 906, the LBT computer platform does not determine that all questions are complete, then, in step 907, the LBT computer platform selects a new question to present to the teachable agent. Processing can then proceed iteratively to step 904 until all questions are completed and answered correctly.

If, in step 905, the LBT system determines that the teachable agent did not answer correctly, then in step 908, the LBT system presents another portion of the graphic user interface configured to enable a user to enter the revise phase. Processing can then proceed to step 906 where the LBT computer platform determines whether all questions are complete. As mentioned above, if, in step 906, the LBT computer platform determines that all questions are complete, then processing ends.

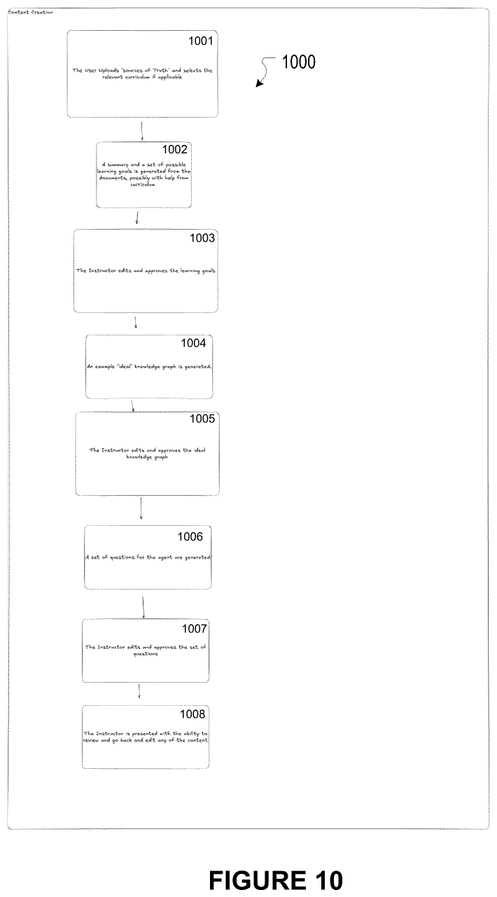

FIG. 10 illustrates an example flow associated with an alternate embodiment of content creation (e.g., generation of new learning modules) facilitated by the LBT computer platform according to various embodiments of the present disclosure. The various functions and features described with respect to FIG. 10 can, at least in part, be performed by or facilitated by a LBT computer platform, such as the system of FIG. 8.

The example flow begins at 1001, the LBT computer platform provides a user with a graphical user interface configured to allow the user to upload content. In this embodiment, content refers to one or more media associated with source material. In this embodiment, source material refers to one or more authoritative and reliable repositories of information (i.e., “sources of truth”) that are considered accurate and up-to-date. Examples of sources of truth can include textbooks, educational databases, scientific journals, etc. Sources of truth can be received in one or more following formats: text, image, audio, video, web and data formats. and selects relevant curriculum if applicable.

In step 1002, the LBT computer platform generates a summary and a set of possible learning goals is generated from documents using one or more machine learning models. In step 1003, the LBT computer platform can receive further instructions from the instructor. For example, in step 1003, the LBT computer platform can receive instructor edits and approval for the generated learning goals.

In step 1004, the LBT computer platform generates an ideal knowledge graph. n this embodiment, the LBT computer platform uses one or more machine learning models to identify key terms and utilize those identified key terms as nodes for the knowledge graph. The LBT computer platform can then generate a set of key learnings. For each key learning, the LBT computer platform can generate a set of updates to the knowledge graph either as updates to the node content or the creation of edges connecting nodes on the graph.

In step 1005, the LBT computer platform receives user input (e.g., from the instructor) to further refine the ideal knowledge graph. In step 1006 the LBT computer platform generates a set of questions for the teachable agent. In this embodiment, the LBT computer platform generates a set of questions for the teachable agent using the identified key terms and generated a set of key learnings.

In step 1007, the LBT computer platform can receive additional edits and confirmation of approval of the question. In step 1008, the LBT computer platform can then present a graphic user interface to the instructor configured to allow the instructor to further review and edit generated content.

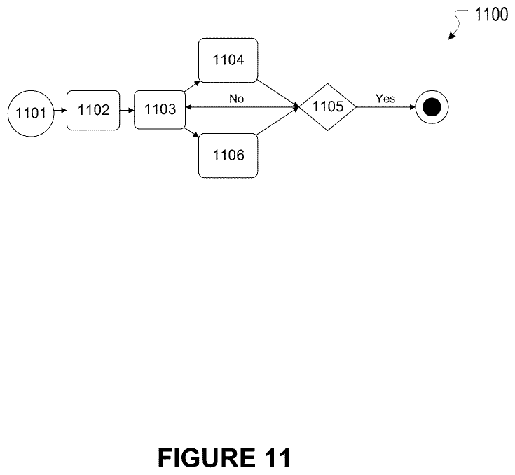

FIG. 11 illustrates an example flow associated with a teaching phase by the LBT computer platform according to various embodiments of the present disclosure. The various functions and features described with respect to FIG. 11 can, at least in part, be performed by or facilitated by a LBT computer platform, such as the system of FIG. 8.

The example flow begins at 1101. At 1102, the LBT computer platform presents a user with a graphical user interface configured to display a set of nodes on a knowledge map. In this embodiment, the LBT computer platform displays a set of disconnected nodes with labels of identified key terms. In step 1103, LBT computer platform receives input from the user (e.g., student). In this embodiment, the LBT computer platform can receive input from the user via a graphic user interface configured to allow the user to provide information for the knowledge map. The student can then decide which node to edit.

In step 1104, the student can make a connection between nodes with an edge connection along with corresponding descriptions or in step 1105 the student can provide additional information for the nodes (e.g., defining and describing a node). In contrast to traditional knowledge graphs where edges are simply defined as a possible relationship (e.g., “works for”), the LBT computer platform presents users with the ability to labeled by the description of the connection the user creates. Further, the LBT computer platform uses graph storage and display interfaces to keep track of user's work on the graph as the graph is being edited. In this embodiment, the LBT computer platform can save logs of changes to the graph for analytics, adaptive learning, and personalization.

In step 1105, the LBT computer platform can receive confirmation that the student is satisfied with how they have taught the teachable agent. In response to receiving confirmation that the student is satisfied, processing can end. In response to receiving confirmation that the student is not satisfied, the LBT computer platform can generate and display a graphic user interface configured to allow the user to provide information for the knowledge map as described in step 1103.

FIG. 12 illustrates an example flow associated with an observe phase by the LBT computer platform according to various embodiments of the present disclosure. The various functions and features described with respect to FIG. 12 can, at least in part, be performed by or facilitated by a LBT computer platform, such as the system of FIG. 8. In this example flow, the LBT computer platform has generated and displayed a virtual space for the student to test the teachable agent and by proxy, the student's knowledge.

The example flow begins at 1201. At 1202, the LBT computer platform provides the portion of the graphic user interface configured to display one or more questions available to test the teachable agent, and by extension, the user's knowledge. The LBT computer platform can further display the teachable agent's workspace to show the knowledge graph and illustrate the reasoning process of the teachable agent. In step 1203, the LBT computer platform presents users with the graphic user interface configured to give students an opportunity to guess or wager the teachable agent's performance. Students can then use the graphic user interface to enter a guess or wager on the teachable agent's performance. In step 1204, the LBT computer platform instructs the teachable agent to answer the presented question.

In step 1205, the teachable agent crafts a query about the knowledge graph. In this embodiment, the teachable agent crafts a query to answer the question by calling one or more Large Language Models (LLM) to determine which retrieval action to take next for the presented question. In this embodiment, the one or more LLMs includes connected tools for graph Retrieval-Augmented Generation (RAG). Examples of retrieval actions include performance of a vector search for a term on the graph, retrieve further information about a node or edge, such as connected nodes, or finish retrieval.

In step 1206 the teachable agent executes the query. After each LLM call, the action is then taken on the graph with the input. In this embodiment, queries can be about specific or groups of nodes and edges and the properties of each. The LLM can then pass back the result as context to the teachable agent for inspection. Accordingly, the teachable agent selects to proceed with the next step. Content in the graph, therefore, informs the thinking process of the teachable agent in real time. The LBT computer platform provides structured text for each call performed by the teachable agent and highlights corresponding nodes of the knowledge graph and edges of the knowledge graph accessed by the teachable agent to answer the query.

Once the teachable agent is finished, it can pass its finding to a final prompt which forms the findings into a simple answer, which follows how the agent has been taught as discussed in step 1207. For example, in step 1207, both the teachable agent is presented with the results of the query while the student is shown the nodes and/or edges retrieved highlighted in the graphic user interface as well as the teachable agent's reasoning for each query made. In this manner, the LBT computer platform illustrates the teachable agent's reasoning by formatting and displaying the teachable agent's reasoning as structured text and highlighted portions on the graph as relevant parts of the teachable agent's brain are revealed for each tool call step. For example, the LBT computer platform highlights key reasoning steps, including assumptions, intermediate calculations, or decision branches.

In step 1208, the teachable agent determines whether it is satisfied with the retrieval of information. If, in step 1208, the teachable agent is not satisfied it has retrieved enough information, then processing reverts back to step 1205. If, in step 1208, the teachable agent is satisfied it has retrieved enough, then, in step 1209, the teachable agent uses the information it has to retrieved to answer as it has been taught. In step 1210, the LBT computer platform displays the teachable agent's final answer and reasoning behind the final answer. For example, the LBT computer platform can display the full reasoning path for review (e.g., nodes and connections it used to answer the question). In step 1211, the LBT computer platform generates a graphic user interface to display a feedback mechanism. For example, the LBT computer platform can generate a display shown on a portion of the graphic user interface for a separate grader to input feedback. In this embodiment, the LBT computer platform may also instruct a feedback agent to grade the teachable agent's answer. In this embodiment, the grade for a question is either correct or incorrect. In step 1212, the LBT computer platform displays the grade to the user.

By performing the steps of example flow 1200, the LBT computer platform generates a real-time visualization of thought processes of the teachable agent. For example, the LBT computer platform can dynamically display reasoning steps using a streaming approach rather than a static block of text. Each step is brought to the front end as it happens. The LBT computer platform can maintain context across user interactions (e.g., paused steps, student queries, etc.) and store logs of observed actions for analytics, adaptive learning, and personalization.

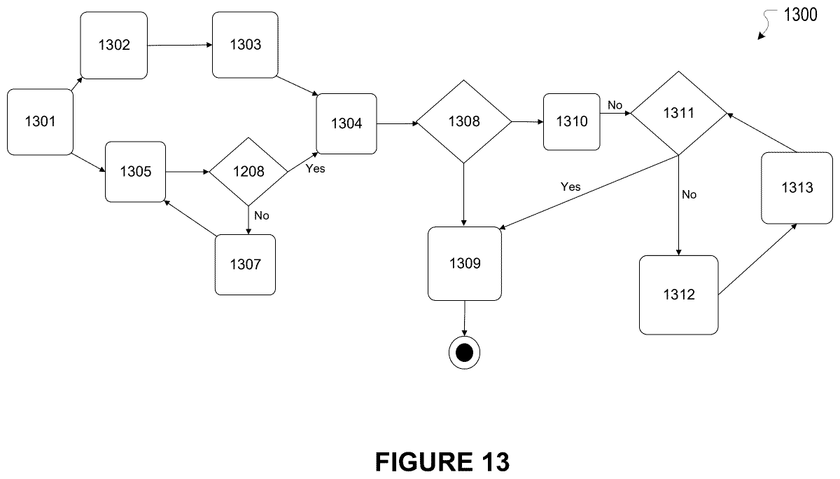

FIG. 13 illustrates an example flow associated with a feedback and grading by the LBT computer platform according to various embodiments of the present disclosure. The various functions and features described with respect to FIG. 13 can, at least in part, be performed by or facilitated by a LBT computer platform, such as the system of FIG. 8. In this example flow, the LBT computer platform grades answers provided by the teachable agent. In this example, the LBT computer platform is graded against both the source of truth provided for the unit as well as the answer of an ideally taught agent. If the answer is graded as incorrect, the LBT computer platform then also identifies points of error in the graph and creates discrepancy feedback which a feedback agent grants to the user if they complete a chat where they answer a reflective feedback question.

In step 1301, the LBT computer platform receives a question, the teachable agent's answer, source of truth text, ideal knowledge graph, and grading rubric. In step 1302, the LBT computer platform generates an answer from the ideal knowledge graph. In step 1303, the LBT computer platform grades the answer generated by the teachable agent by comparing the teachable agent's answer (generated using the ideal knowledge graph) to the ideal answer. In step 1304, the teaching agent rectifies the discrepancies between the agent and graph results.

In parallel to steps 1302 and 1303, in step 1305, the LBT computer platform grades the teachable agent's answer (generated using the student's created knowledge graph) to the source of truth and ideal answer. In step 1306, the LBT computer platform determines whether the grade makes sense to another LLM. If, in step 1306, the LBT computer platform determines that the grade does not make sense, then, in step 1307, the LBT computer platform instructs the agent to provide constructive feedback on the grade given. Processing can then proceed back to step 1305. In step 1304, the teaching agent rectifies the discrepancies between the agent and graph results.

If, in step 1306, the LBT computer platform determines that the grade does make sense, then, processing continues at step 1304. In step 1308, the LBT computer platform determines whether the final grade is correct. In this embodiment, the LBT computer platform passes the text to an additional LLM call which determines whether the grade should be correct or incorrect. That grade is then passed to a reviewer LLM call, who will offer suggestions on how to improve the accuracy of the grader. The LBT computer platform can then finalize the grade and return the justification for the grade.

If, in step 1308, the LBT computer platform determines whether the final grade is correct, then, in step 1309, the LBT computer platform returns the grade and feedback object.

If, in step 1308, the LBT computer platform determines whether the final grade is correct, then, in step 1310, the LBT computer platform identifies relevant discrepancies. In this embodiment, the LBT computer platform calculates the discrepancy between the teachable agent's answer and the ideal answer. For example, the LBT computer platform identifies a location (e.g., a node, edge) on the teachable agent's knowledge map is selected as being the site of the issue. Put another way, the LBT computer platform can identify this location as where the information is incorrect or missing.

In step 1311, the LBT computer platform determines whether feedback is generated for all discrepancies. In this embodiment, the LBT computer platform generates a set of feedback targeting the discrepancy from the idea answer.

If, in step 1311, the LBT computer platform determines that feedback is generated for all discrepancies, then, processing proceeds to step 1309. In step 1313, the LBT computer platform adds the LLM diagnoses and reflective question.

If, in step 1311, the LBT computer platform determines that the feedback is not generated for all discrepancies, then, in step 1312, the LBT computer platform calls an LLM to diagnose where on the knowledge graph the relevant occurred and creates a reflective question. The LBT computer platform can generate a reflective question such as “where did you get the knowledge that the teachable agent had to use from this section?” In step 1313, the LBT computer platform adds the diagnoses to the feedback object and accordingly return the grade and feedback object.

In this embodiment, the LBT computer platform can generate and display a graphic user interface for an LLM chat agent that can display feedback in exchange for user answer the reflective question. In some embodiments, the LBT computer platform can provide the user with expert feedback in addition to providing additional resources for the student.

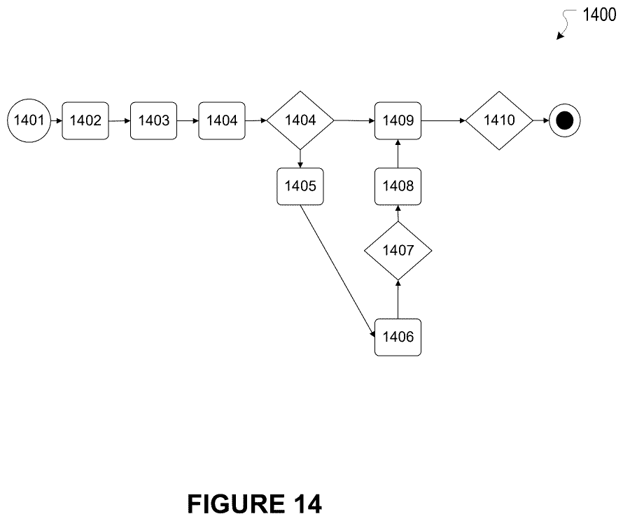

FIG. 14 illustrates an example flow associated with a revise phase by the LBT computer platform according to various embodiments of the present disclosure. The various functions and features described with respect to FIG. 14 can, at least in part, be performed by or facilitated by a LBT computer platform, such as the system of FIG. 8.

In step 1401, the LBT computer platform identifies the nodes and edges with issues. In this embodiment, the LBT computer platform highlights the identified nodes and edges with issues in the graphic user interface. In step 1402, the LBT computer platform receives user input. For example, the LBT computer platform receives user input when the user clicks on a highlighted node/connection. In step 1403, the LBT computer platform shows an expert offer to provide discrepancy/explanatory feedback. In step 1404, the LBT computer platform determines whether or not the user accepts the offer. If, in step 1404, the LBT computer platform determines that the user has accepted the offer, then, in step 1405, the LBT computer platform prompts the user to answer a reflective feedback prompt in exchange for the discrepancy feedback. In step 1406, the LBT computer platform then receives the user answer. In step 1407, the LBT computer platform passes the answer to an expert agent to determine whether the answer provided by the student is acceptable. If, in step 1407, the expert agent determines the answer provided by the student as not acceptable, then processing continues to step 1405. If, in step 1407, the expert agent determines that the answer provided by the student is acceptable, then, in step 1408, the LBT computer platform displays the explanatory/discrepancy feedback. Processing then continues to step 1409.

In step 1409, the LBT computer platform provides a graphic user interface for the user to make changes to the node/connection description. In step 1410, the LBT computer platform determines whether all the highlighted nodes have been fixed or whether the user wants to proceed. If, in step 1410, all the highlighted nodes have been fixed or the user wants to proceed, then processing terminates. If, in step 1410, all the highlighted nodes have not been fixed or the user does not want to proceed, then processing reverts to step 1402.

What is claimed is:

1. A computer-implemented method for a learn by teaching platform comprising:
displaying, by one or more processors, a graphic user interface that includes a first portion configured to enable a user to create a knowledge graph for a learning module;
creating, by the one or more processors, the knowledge graph based on inputs received from the first portion of the graphic user interface;
selecting, by the one or more processors, one or more questions for a teachable agent to answer using the created knowledge graph; and
in response to receiving answers for the one or more questions, generating, by the one or more processors, a real-time visualization of thought processes of the teachable agent.

2. The computer-implemented method of claim 1, further comprising:
generating, by the one or more processors, feedback for the received answers by identifying points of error on the created knowledge graph used to answer the one or more questions.

3. The computer-implemented method of claim 2, further comprising:
providing, by the one or more processors, the first portion of the graphic user interface to enable the user to modify the created knowledge graph based on the generated feedback.

4. The computer-implemented method of claim 3, further comprising:
determining, by the one or more processors, conceptual understanding of the user for a topic based on performance of the teachable agent.

5. The computer-implemented method of claim 1, wherein the graphic user interface includes a second portion that displays the one or more questions for the teachable agent to answer.

6. The computer-implemented method of claim 5, wherein the graphic user interface includes a third portion that displays the real-time visualization of thought processes of the teachable agent.

7. The computer-implemented method of claim 6, wherein the graphic user interface includes a fourth portion that displays a virtual space to test knowledge of the teachable agent for a topic.

8. The computer-implemented method of claim 1, further comprising:
generating, by the one or more processors, a learning module from received content associated with source material;
extracting, by the one or more processors, one or more key terms and key learnings from the received content; and
utilizing, by the one or more processors, the extracted one or more key terms as a set of nodes for the knowledge graph and the key learnings to update the knowledge graph.

9. The computer-implemented method of claim 1, wherein generating, by the one or more processors, a real-time visualization of thought processes of the teachable agent comprises:
generating, by the one or more processors, structured text for retrieval actions performed by the teachable agent; and
highlighting, by the one or more processors, corresponding nodes and edges of the knowledge graph accessed by the teachable agent to answer the one or more questions.

10. The computer-implemented method of claim 1, wherein inputs received from the first portion of the graphic user interface comprise text descriptions for respective nodes and user drawn connections between nodes of the knowledge graph and associated text description for respective connections provided by the user.

11. A computer program product for a learn by teaching platform comprising:
one or more processors and one or more computer readable storage media that when executed by the one or more processors, cause program instructions stored on the one or more computer readable storage media to:
display a graphic user interface that includes a first portion configured to enable a user to create a knowledge graph for a learning module;
create the knowledge graph based on inputs received from the first portion of the graphic user interface;
select one or more questions for a teachable agent to answer using the created knowledge graph; and
in response to receiving answers for the one or more questions, generate a real-time visualization of thought processes of the teachable agent.

12. The computer program product of claim 11, wherein the program instructions stored on the one or more computer readable storage media that when executed by the one or more processors further comprise program instructions to:
generate feedback for the received answers by identifying points of error on the created knowledge graph used to answer the one or more questions.

13. The computer program product of claim 12, wherein the program instructions stored on the one or more computer readable storage media that when executed by the one or more processors further comprise program instructions to:
provide the first portion of the graphic user interface to enable the user to modify the created knowledge graph based on the generated feedback.

14. The computer program product of claim 11, wherein the program instructions stored on the one or more computer readable storage media that when executed by the one or more processors further comprise program instructions to:
determine conceptual understanding of the user for a topic based on performance of the teachable agent.

15. The computer program product of claim 11, wherein the graphic user interface includes a second portion that displays the one or more questions for the teachable agent to answer.

16. The computer program product of claim 15, wherein the graphic user interface includes a third portion that displays the real-time visualization of thought processes of the teachable agent.

17. The computer program product of claim 11, wherein the program instructions stored on the one or more computer readable storage media that when executed by the one or more processors further comprise program instructions to
generate a learning module from received content associated with source material;
extract one or more key terms and key learnings from the received content; and
utilize the extracted one or more key terms as a set of nodes for the knowledge graph and the key learnings to update the knowledge graph.

18. The computer program product of claim 11, wherein the program instructions to generate a real-time visualization of thought processes of the teachable agent comprise program instructions that, when executed by the one or more processors further cause the program instructions to:
generate structured text for retrieval actions performed by the teachable agent; and
highlight corresponding nodes and edges of the knowledge graph accessed by the teachable agent to answer the one or more questions.

19. The computer program product of claim 11, wherein inputs received from the first portion of the graphic user interface comprise text descriptions for respective nodes and user drawn connections between nodes of the knowledge graph and associated text description for respective connections provided by the user.

20. A computer system for a learn by teaching platform comprising:
one or more processors;
one or more computer readable storage media; and
program instructions stored on the one or more computer readable storage media that, when executed by the one or more processors, cause the one or more computer readable storage media to:
display a graphic user interface that includes a first portion configured to enable a user to create a knowledge graph for a learning module;
create the knowledge graph based on inputs received from the first portion of the graphic user interface;
select one or more questions for a teachable agent to answer using the created knowledge graph; and
in response to receiving answers for the one or more questions, generate a real-time visualization of thought processes of the teachable agent.
